(19) United States
(12) Patent Application Publication
(10) Pub. No.: US 2009/0265137 A1
(43) Pub. Date: Oct. 22, 2009

(54) COMPUTER-BASED METHODS AND SYSTEMS FOR FAILURE ANALYSIS

(75) Inventors: Takayuki Iida, Billerica, MA (US); Stanley Sangjin Kim, Watchung, NJ (US); Roberta E. Benson, Groton, MA (US)

Correspondence Address: LANDO & ANASTASI, LLP, ONE MAIN STREET, SUITE 1100, CAMBRIDGE, MA, 02142, US

(73) Assignee: HAMAMATSU PHOTONICS K.K., Hamamatsu-Shi (JP)

(21) Appl. No.: 12/105,741

(22) Filed: Apr. 18, 2008

(51) Int. Cl. G06F 15/00

(52) U.S. Cl. 702/183

(57) ABSTRACT

In accordance with one aspect, the invention provides a method of performing failure analysis on a microelectronic product where the method includes acts of: storing a result of a first test performed on the microelectronic product on a centralized computer; transmitting the result from the centralized computer to a first remote computer for an evaluation of the result by a first evaluator; and transmitting a report form from the centralized computer to the first remote computer for entry of data including analysis supplied by the first evaluator after the evaluation of the result. In accordance with one embodiment, the method also provides acts of: receiving the data at the centralized computer; and storing the data at the centralized computer. In accordance with another embodiment, the method further includes an act of transmitting the result from the centralized computer to a second remote computer for an evaluation of the result by a second evaluator for entry of data including analysis supplied by the second evaluator after the evaluation of the result by the second evaluator.

### BACKGROUND OF INVENTION

1. Field of Invention

At least one embodiment of the invention relates to failure analysis, and in particular, to failure analysis of microelectronic products.

2. Discussion of Related Art

Today, the manufacturing of semiconductors and other microelectronic products is a substantial worldwide enterprise. As a result, the manufacturing and supply chain for products that include microelectronic products may involve geographically disperse operations, where for example, manufacturing facilities may be widely separated from design facilities and from some testing facilities. As used herein the term microelectronic product is intended to include semi-conductor wafers, microchips, printed circuit boards, microelectronic packages, microelectronic devices, and modules that may include printed circuit boards and a plurality of microelectronic devices. In addition, the term microelectronic product is also intended to include any of the preceding in which an organic semiconductor is employed.

As one example of the nature of today's manufacturing of microelectronic products, a first manufacturing plant for the manufacture of microelectronic products may include a fabricating line (also referred to as a “fab”). The same manufacturing site that includes the fab may also include a lab, for example, a failure analysis lab. The role of the failure analysis lab generally is to assist in the quality control and trouble-shooting in the manufacture of the product and manufacturing process employed at one or more fabs. However, the failure analysis of microelectronic products requires expensive laboratory equipment and can require one or more of a scanning electron microscope (“SEM”), a transmission electron microscope (“TEM”), an electron probe micron analyzer and various other equipment used to test the electronic and physical characteristics of the microelectronic products. The testing may provide an initial assessment of manufacturing quality and/or result from a report of a defect identified in the field.

Accordingly, many companies employ one or more failure analysis labs to service a plurality of other sites which may include manufacturing and/or design centers. Often, one or more of these facilities are located geographically remote from one another. Further, failure analysis labs that are remote from one another may each include only some of the required equipment and/or personnel. Accordingly, a series of integrated tests and analysis of test results may require the use of resources at a plurality of locations that may be geographically remote from one another.

### SUMMARY OF INVENTION

In various embodiments the invention provides methods and systems that can be web-based and allow collaboration between a plurality of engineers/analysts located remotely from one another where the engineers/analysts can each contribute to failure analysis performed on microelectronic products. For example, in some embodiments, a plurality of engineers/analysts can access remote databases concerning the failure analysis for both read and write access. These embodiments can allow failure analysis reports to be developed collaboratively where each contributor can directly add or modify the contents of the report. In some embodiments, access and modification of the contents of a failure analysis report is provided over wide-area network. Further, some embodiments allow the integration of a plurality of tests and/or test reports into a single failure analysis report. In some further embodiments, resource management of failure analysis may be performed by one or more individuals who may or may not be remote from both a location of the test equipment and a location of the analyst(s). In some embodiments, the resource management can include oversight of interim results and analysis and the scheduling of further testing an analysis in view of the interim results.

In accordance with one aspect, the invention provides a method of performing failure analysis on a microelectronic product where the method includes acts of storing: a result of a first test performed on the microelectronic product on a centralized computer; transmitting the result from the centralized computer to a first remote computer for an evaluation of the result by a first evaluator; and transmitting a report form from the centralized computer to the first remote computer for entry of data including analysis supplied by the first evaluator after the evaluation of the result. In accordance with one embodiment, the method also provides acts of: receiving the data at the centralized computer; and storing the data at the centralized computer. In accordance with another embodiment, the further includes an act of transmitting the result from the centralized computer to a second remote computer for an evaluation of the result by a second evaluator for entry of data including analysis supplied by the second evaluator after the evaluation of the result by the second evaluator.

In another aspect, the invention provides a computer-based system for performing failure analysis on a microelectronic product where the system includes a centralized computer. In accordance with one embodiment, the centralized computer includes a file server configured to store report forms, and at least one remote computer configured to be employed by a user qualified to evaluate test data concerning the microelectronic product, wherein the user is qualified to provide a report form with analysis including recommendations for further testing and a determination of a root cause of a failure of the microelectronic product based upon a review of the test data. In a further embodiment, the centralized computer is configured to receive the report form from the remote computer over a wide area network and to store the report form on the file server. In accordance with one embodiment, the centralized computer includes a database server configured to store test data concerning testing performed on the microelectronic product, and a report generation module configured to generate report forms to be completed by personnel qualified to evaluate the test data.

In still another embodiment of the computer-based system, the user is a first user, wherein the report generation module is configured to generate a report form to be completed by a second user, wherein the report form to be completed by the second user includes at least one field with analysis provided by the first user, and wherein the second user is qualified to evaluate the test data concerning the microelectronic product and provide analysis including recommendations of the second user for further testing and the determination of the root cause of the failure of the microelectronic product based upon a review of the test data by the second user.

In yet another aspect, the invention provides a method of performing failure analysis on microelectronic product including acts of storing a result of a first test performed on the microelectronic product on a centralized computer, transmitting the results from the centralized computer to a first remote computer over a wide-area network, for an evaluation of the result by a first evaluator, and storing at the centralized computer data received from the first remote computer. In accordance with one embodiment, the data includes analysis supplied by the first evaluator after the evaluation of the result. In accordance with another embodiment, the method includes an act of transmitting a report form from the centralized computer to the first remote computer for entry of the analysis supplied by the first evaluator. In a version of this embodiment, the method includes an act of rendering a report form in a web browser of the first remote computer.

In yet another embodiment, the method includes an act of transmitting the result from the centralized computer to a second computer for an evaluation of the result by a second evaluator. In accordance with one embodiment, the second computer is a remote computer and the method includes an act of transmitting the data from the centralized computer to the second computer. In still another version, the method includes an act of storing at the centralized computer data received from the second computer wherein the data includes analysis supplied by the second evaluator after the evaluation of the result by the second evaluator. In accordance with another embodiment, the method includes an act of generating a failure analysis report including analysis supplied by the first evaluator and the second evaluator. In accordance with a further embodiment, the method includes an act of including the result of the first test in the failure analysis report.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a system for performing failure analysis in accordance with one embodiment;

FIG. 2A illustrates a system that includes remote users in accordance with one embodiment;

FIG. 2B illustrates a system that includes separate facilities in accordance with another embodiment;

FIG. 3 illustrates a system for performing failure analysis in accordance with another embodiment;

FIG. 4 illustrates a system for performing failure analysis in accordance with yet another embodiment;

FIG. 5 illustrates a display in accordance with one embodiment of the invention;

FIG. 6 illustrates a display in accordance with another embodiment of the invention;

FIG. 7 illustrates a display in accordance with yet another embodiment of the invention;

FIG. 8 illustrates a display in accordance with a further embodiment of the invention;

FIG. 9 illustrates a display in accordance with still another embodiment of the invention;

FIG. 10 illustrates a display in accordance with a further embodiment of the invention;

FIG. 11 illustrates a display in accordance with yet another embodiment of the invention;

FIG. 12 illustrates a display in accordance with another embodiment of the invention;

FIG. 13 illustrates a display in accordance with still another embodiment of the invention;

FIG. 14 illustrates a display in accordance with a still further embodiment of the invention; and

FIGS. 15A and 15B illustrate a failure analysis process in accordance with one embodiment.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Present lab management systems do not provide an effective approach to the integration of resources that can be geographically separate from one another. In particular, present systems do not provide engineers (or other qualified personnel) with an effective system for collaborating in a failure analysis of a microelectronic product. For example, present systems make it difficult for such personnel to collaboratively prepare a failure analysis report in an efficient manner.

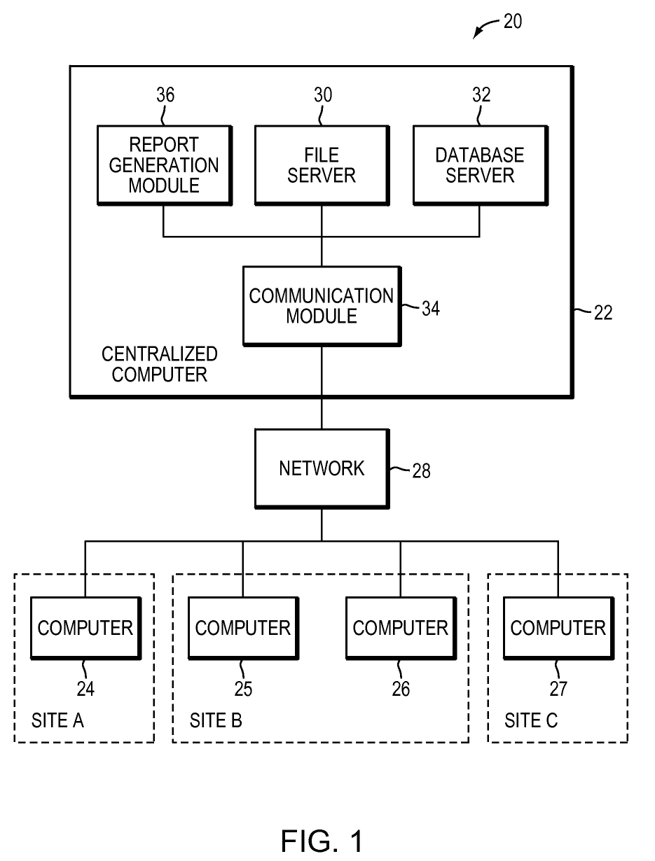

FIG. 1 refers to a computer-based system 20 for performing failure analysis on a microelectronic product. The computer-based system 20 includes the centralized computer 22 and a plurality of remote computers. As illustrated in FIG. 1, the remote computers include a first remote computer 24, a second remote computer 25, a third remote computer 26 and a fourth remote computer 27. The centralized computer 22 and the remote computers are connected over a network 28. In accordance with one embodiment, the centralized computer 22 includes a file server 30, a database server 32, a communication module 34 and a report generation module 36.

In accordance with one embodiment, the network 28 is a wide area network, for example, the Internet. The centralized computer 22 may be configured in any of a variety of configurations. That is, although various modules are illustrated, the centralized computer may be a single computer, a plurality of computers, and the centralized computer may be made up of a single server, plurality of discrete servers or may integrate the functionality of the servers in a single machine. For example, in accordance with one embodiment, the centralized computer 22 is a single machine that includes each of the file server 30, database server 32, communication module 34 and report generation module 36. The immediately preceding approach is sometimes referred to as an “all-in-one” server configuration. In accordance with another embodiment, however, one or more of the file server 30 and database server 32 are included in one or more separate machines that are included in the centralized computer 22. For example, the file server 30 may be included in a first machine along with the communication module 34 while the database server 32 is in a separate machine. This configuration is sometimes referred to as “an external database” configuration. Further, in another embodiment, both the file server 30 and the database server 32 are in separate machines that are distinct from the web server that includes a communication module 34. However, in each of the preceding examples, the file server 30, database server 32, communication module 34 and report generation module 36 are included in the centralized computer 22.

As a further example, the centralized computer 22 may include a plurality of web servers for load balancing where each of the plurality of web servers is connected to a common database server or servers. This approach is sometimes referred to as a “web-farm” configuration.

Thus, as described above, the configuration of the centralized computer 22 need not be restricted to any one hardware configuration. According to some embodiments, the term “centralized computer” refers to the portion of the system 20 that includes the functionality associated with the file server 30, the database server 32, the communication module 34 and the report generation module 36.

In accordance with a further embodiment, the database server 32 is configured to store test data concerning testing performed on microelectronic products, while the report generation module 36 is configured to generate report forms to be completed by personnel qualified to evaluate the test data and the file server 30 is configured to store report forms including information provided by the personnel qualified to evaluate the test data. In accordance with one embodiment, the communication module 34 is configured to transmit report forms from the centralized computer system to remote computers for entry of information by personnel qualified to evaluate the test data. It will also be recognized that the report generation module 36 may be included elsewhere within the centralized computer 22. For example, the report generation module 36 may be included as a part of the communication module 34.

As used herein, the terms “file server” and “database server” are employed to describe the functionality of two subsystems of the centralized computer. In some embodiments, these functions are merged into a single server. In accordance with some embodiments, a database management system (for example, an Oracle DBMS) can “serve” files, that is, the database management system can store and disseminate files. Accordingly, in one embodiment, a database server also performs the functions of the file server while in another embodiment a file server also performs the functions of a database server.

In various embodiments, one or more of the computers is located geographically remote from the centralized computer 22. In accordance with one embodiment, the computer 22 is located at a first site, the computer 25 and the computer 26 are located at a second site and the computer 27 is located at a third site. In one version of this embodiment, the computer 25 and the computer 26 are located remote from one another at the second site. Various embodiments of each of these computers operate as a client computer and the centralized computer 22 operates as a host computer.

In various embodiments, the centralized computer transmits not only report forms but test data, analysis, and other information that has been collected and stored from any one of the parties connected to the system 20 via the network 28.

In addition to or in combination with one or more of the embodiments described thus far, the geographic distribution of the resources included in the computer-based system 20 may vary.

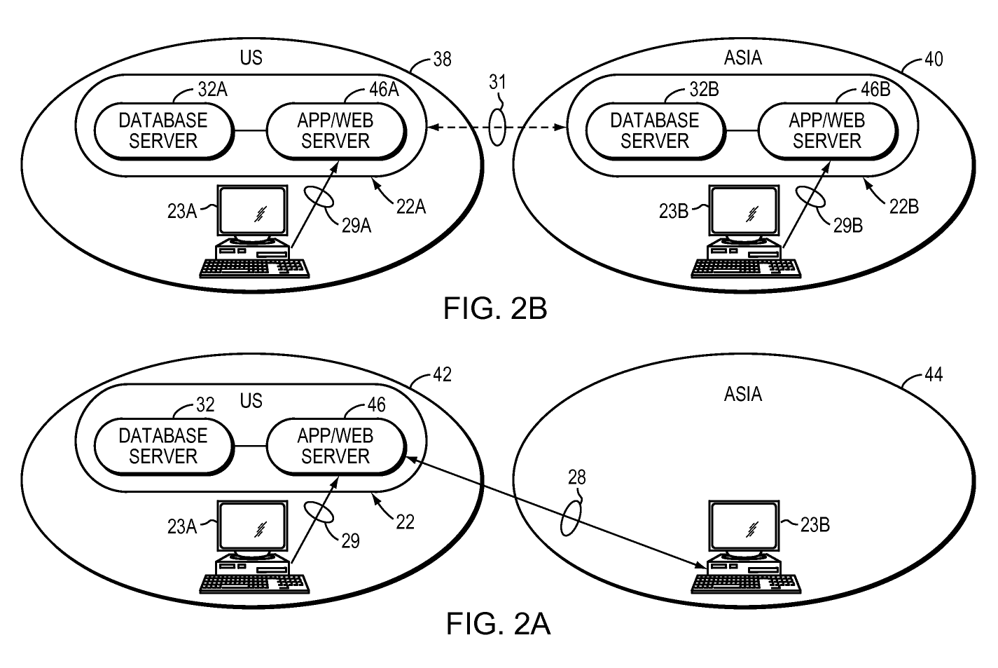

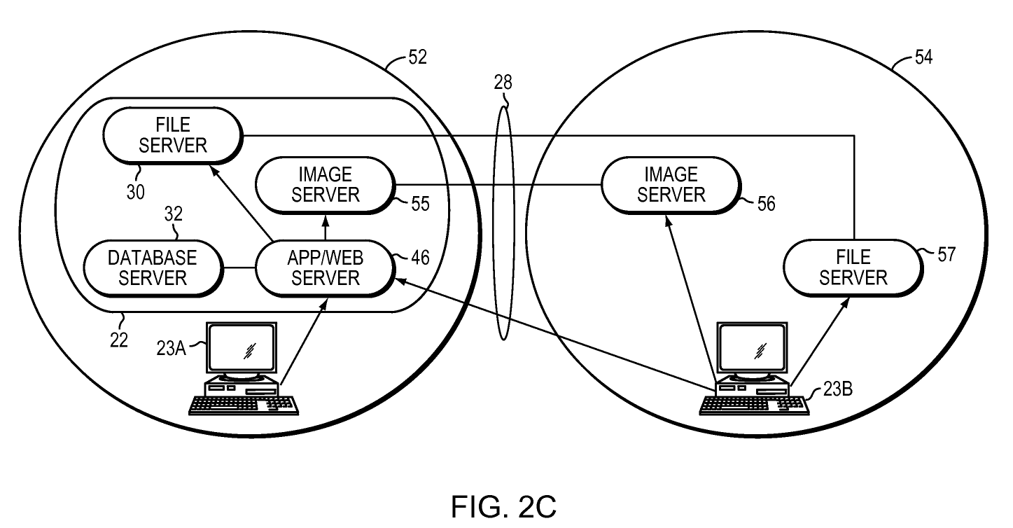

Referring now to FIG. 2A, a first site 42 is located at a first location and a second site 44 is located in a second location. In one embodiment, each of the first site 42 and the second site 44 include a fab. In further embodiments, each of the first site 42 and the second site 44 can include any of a fab, a design facility, a test lab or other facilities alone or in combination with the preceding. Further, each location may include a plurality of computers 23, where one or more of the plurality of computers is a remote computer. In the embodiment illustrated in FIG. 2A, the first site 42 includes a centralized computer 22 which services both the first site 42 and the second site 44. In accordance with one embodiment, the computers 23A and 23B located at each of the first site 42 and second site 44, respectively, communicate with the central computer 22 located at the first site 42 over a network 29 and a network 28, respectively. In accordance with one embodiment, the network 28 and the network 29 are included in the same network. In an alternate embodiment, the network 28 is a separate stand alone network. For example, each of the network 28 and the network 29 may be included in a single wide area network, or alternatively, the network 28 and the network 29 may be included in separate wide area networks where each is in communication with the centralized computer 22. In some embodiments, regardless of the network configuration, each of the networks 28 and 29 provide the computers connected to each, respectively, with substantially the same functionality. That is, each of the computers 23A and 23B can provide a user with access to test results stored at the centralized computer, an ability to enter analysis for storage at the centralized computer, an ability to review image data stored at the centralized computer, etc.

In accordance with one embodiment, the network 28 and the network 29 each include the Internet. In accordance with another embodiment, one or both of the network 28 and the network 29 include a LAN.

As illustrated in FIG. 2A, the centralized computer 22 includes both a database server 32 and an application/web server 46. Thus, in one embodiment, the centralized computer 22 provides remote hosting for the computers 23B included at the second site 44. In a further embodiment, the centralized computer 22 provides hosting to the computers 23A included at the first site 42. In some embodiments, one or more of the computers 23A are located remote from the centralized computer 22 at the first site 42. These remote computers may be located apart from one another at a single location or may be located geographically remote from the centralized computer. That is, where the first site 42 includes a plurality of locations in the U.S., for example, one or more remote computers may be located in a different city or state than the centralized computer.

According to one embodiment, data from the second site 44 is stored at the first site 42 in the centralized computer 22, for example, in the database server 32. In various embodiments, users at the second site 44 have both read and write access to information stored at the first site 42, in particular, on the database server 32. That is, an analyst located at the second site 44 can transmit analysis and/or test data from the second site 44 to the first site 42 for storage via the computers 23B. In addition, the information provided from the second site 44 may include image files, spreadsheets, text documents and the like. In accordance with one embodiment, the application/web server 46 transmits a report form to the computer 23B where the analyst can complete or partially complete the form, transmit the form back to the second site 42 where that information is stored on the centralized computer.

As is explained in greater detail herein, some embodiments provide an even more broad range of operation that is made available to a plurality of users who may be located remote from one another. For example, according to some embodiments, the system illustrated in FIG. 2A is employed in a failure analysis process that includes product tests; review of test results by an analyst qualified to reach a conclusion concerning a failure of a microelectronic device; the scheduling of a subsequent set of tests as a result of the review by the first analyst; review of the subsequent test results by the first analyst or a different analyst located remote from the first analyst; and generation of a report including contributions (i.e., information provided by) the first analyst and the second analyst.

In various embodiments, the preceding is achieved where any of the analysts, any of the fabs, and any of the testing may be performed at two or more locations that can be remote from one another, for example, geographically remote from one another. In addition, other personnel and/or facilities remote from one or more of the preceding may also be integrated into the failure analysis process. For example, a customer located in a location distinct from each of the first fab 42 and the second fab 44 may access the centralized computer 22 (for example, over a wide area network) to review test results or the progress of the process more generally. As another example, a manager may have access to the centralized computer system to contribute to the analysis and/or report generation and also to coordinate the allocation of resources (both personnel and equipment). The manager can be located at the first site 42, the second site 44 or another location from which the manager is able to access the centralized computer 22.

As mentioned above, in some embodiments, the centralized computer 22 provides functionality that allows collaboration by a plurality of individuals who can be remote from one another and/or remote from one or more resources in the failure analysis process. Accordingly, the approaches described herein provide a flexible approach that supports a variety of system configurations. For example, referring now to FIG. 2B, a first site 38 and a second site 40 are illustrated where the sites are located at separate locations and each site includes a centralized computer: the first centralized computer 22A and the second centralized computer 22B, respectively. In the illustrated embodiment, the first site 38 includes a first database server 32A and a first application/web server 46A while the second site 40 includes a second database server 32B and a second application web/server 46B.

In accordance with one embodiment, each of the systems is a stand alone system relative to the other as they need not communicate with one another. Instead, clients at each of the two sites are serviced by the local centralized computer 22A or 22B. That is, each of the first computers 23A is in communication with the centralized computer 22A via a network 29A and each of the second computers 23B is in communication with the centralized computer 22B via a separate network 29B.

For example, the first site 38 may include a plurality of computers 23A that are located remotely from the first centralized computer 22A. These remote computers may be located within a single facility or a plurality of facilities included at the first site 38A. That is, the centralized computer 22A may be connected to remote computers at a single facility, for example, in Texas or one or more computers 23A located at each of a fab in Texas, a design center in California, or additional locations in the U.S. Similarly, the second centralized computers 22B may include one or more computers 23B that are remote from the second centralized computer 22B. That is, the second centralized computer 22A may be connected to remote computers located at a single facility, for example, in Singapore, or one or more computers located in each of Singapore, Japan and/or additional locations in Asia. As will be apparent to those of ordinary skill in the art, the centralized computers may be located at any location worldwide and the North American and Asian locations are only presented here as one possible example. Thus, a plurality of centralized computers may be employed to separately serve a plurality of users involved in a failure analysis process where the users share a common aspect such as their relative locations and/or the facilities or product lines with which they are associated. Further, the first network 29A and the second network 29B can include a wide area network or a local area network to connect the first computers 23A and the second computers 23B to the first and second network, respectively.

According to a further embodiment, a network 31 may optionally be employed to allow communication between the first centralized computer 22A and the second centralized computer 22B. The communication may be available on a substantially continuous basis or only periodically, for example, to synchronize the contents of one or more selected system elements.

Referring now to FIG. 2C, in another embodiment, a first site 52 and a second site 54 communicate over a network 28. In the illustrated embodiment, the second site has read access and write access to applications located at the first site 52. In one embodiment, the first site includes a database server 32, an application web/server 46, an image server 55 and a file server 30. Further, the database server 32 is in communication with the application/web server 46 and the application/web server is in communication with each of the image server 55 and one or more computers 23A. In addition, the application/web server is in communication with computers 23B located at the second site 54 via the network 28.

In accordance with one embodiment, the system illustrated in FIG. 2C differs from the embodiment illustrated in FIG. 2A because the second site 54 includes an image server 56 and a file server 57. In accordance with one embodiment, the image server 56 is in communication with the image server 55 and the computers 23B located at the second site 54, and the file server 57 is in communication with the file server 30 and the computers 23B. In various embodiments, the contents of the image servers are periodically updated/replicated such that each of the first site 52 and the second site 54 include an image server with the same content. Similarly, the contents of the file servers are also updated/replicated such that the first site 52 and the second site 54 include a file server with the same content. Further, in one embodiment, each of the image server 55 and the file server 30 are included in a single server and each of the image server 56 and the file server 57 are included in a single server.

In operation, this approach reduces an amount of information that must be transmitted over the network 28 on a real-time basis because it reduces the need to transmit images via the network 28 to analysts located at the second site 54. According to one embodiment, the network is a wide area network. In some embodiments, the centralized computer may also include additional servers or a single server that handles not only image data and text data but also files of various types, for example, PDF files, graphic files, and the like. In versions of this embodiment, local access is provided at each of the first site 52 and the second site 54 to each of the various file types stored on the respective servers 30, 55, 56 and 57. As a result, transmission of information across a network is greatly reduced and an analyst may more easily and quickly access locally saved data when performing analysis and preparing reports. In accordance with various embodiments, the centralized computer 22 may include a file server that stores text files, image files, graphics files, etc. Alternatively, the functions of the file server may be distributed across two or more servers based on the file-type that is being stored.

In accordance with one embodiment, the approach illustrated in FIG. 2C need only replicate files and not the database. This approach can be more efficient because the files (including image files) do not contain complex relationships such as those found with the information located on the database server.

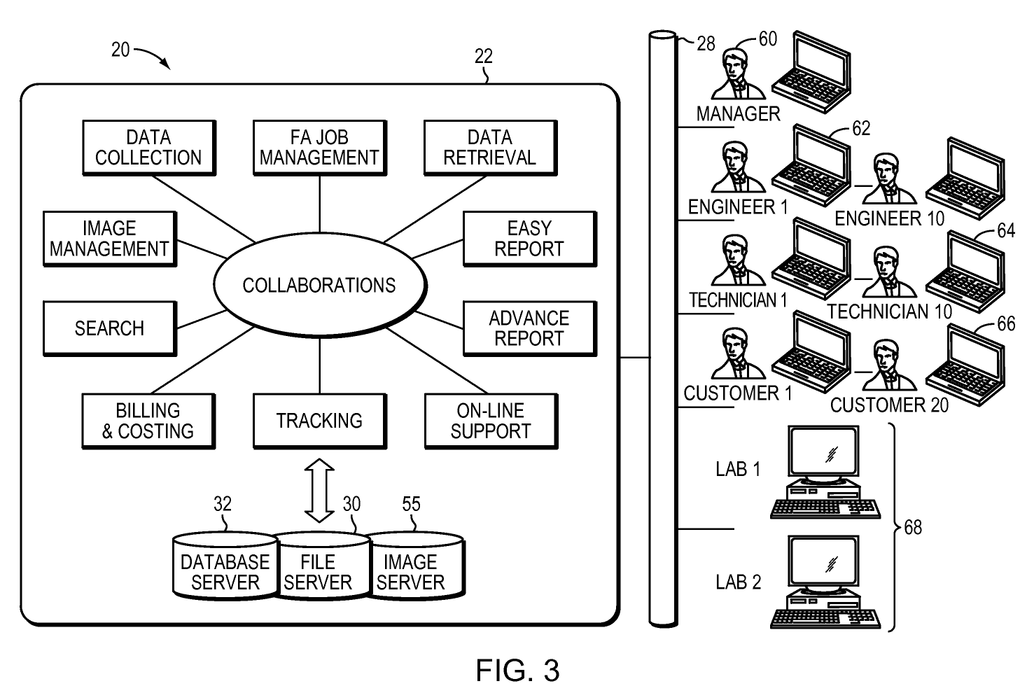

Referring now to FIG. 3, a block diagram of a computer-based system 20 for performing failure analysis is illustrated in accordance with another embodiment. In various embodiments, the computer-based system 20 may be employed to perform failure analysis on microelectronic products. In other embodiments, however, the computer-based system 20 may be employed in other fields, for example, in the fields of pharmaceutical and drug development, drug screening, pathology and collaborative disease diagnosis or wherever else multi-step analysis requires the collaboration of multiple skilled individuals and/or different facilities which are geographically remote from one another. Some embodiments are well suited for use in the field of photonics because they provide an efficient approach to managing failure analysis across an enterprise that can include multiple sites that are geographically remote from one another. According to one embodiment, the computer-based system 20 is employed in the failure analysis of photonic devices, for example, in the failure analysis of semiconductor photonic devices. In a further embodiment, the ability to collaboratively share image data with the computer-based system 20 (including image data that is annotated by one or more of the collaborators) is beneficial for a process of disease diagnosis in which images of tissue are employed.

FIG. 3 illustrates some of the types of personnel and sites that may employ the computer-based system 20 in a collaborative fashion to request failure analysis, perform failure analysis, determine a root cause of failures, report the results of failure analysis (including intermediate results) and store information concerning failure analysis for later review and development of expert content. As illustrated in FIG. 3, these personnel and sites which are all connected by the network 28 may include one or a plurality of managers 60, engineers 62, technicians 64, customers 66, labs 68, manufacturing facilities, design facilities, customer support, finance, etc. The above-mentioned individuals and sites may communicate with a centralized computer 22 to perform the functions illustrated in FIG. 3 and other functions relevant to their field of analysis. In accordance with one embodiment, the collaborative work environment provides an ability to perform failure analysis job management, failure analysis job tracking, and failure analysis job billing and costing. Further, the data collection and ability to retrieve and review stored data are also included in the capability of the computer-based system 20. Additional operations including image management, search and report functions, and advance report functions may also be included in the system 20. Because failure analysis is often requested by customers (external or internal), the computer-based system 20 may also include on-line support for various operations that may be performed using the system by internal and external customers.

Further, in some embodiments, the computer-based system 20 allows customers direct on-line access to the computer-based system such that they may directly request failure analysis on an item, track the status of the failure analysis and review reports prepared concerning the analysis.

The overall operation of the computer-based system 20 provides, in one embodiment, an ability to conduct failure analysis in an efficient and centralized manner even where the individuals and facilities involved in the failure analysis may be located at different locations. The locations may be different locations in the same facility or sites that are geographically remote from one another.

In accordance with one embodiment, the manager 60 is responsible for managing the failure analysis process, in particular, the flow of one or more failure analysis jobs using the computer-based system 20. As such, the manager can assign responsibilities for failure analysis to a variety of personnel including the engineers 62 and technicians 64. In addition, the manager can allocate lab resources from the labs 68 to conduct the failure analysis using lab equipment and can do so in an efficient manner. For example, the computer-based system 20 may allow the manager 60 to identify available pieces of lab equipment and to schedule testing on a particular item during periods of lower utilization of the equipment.

The engineer 62 generally performs the analysis of test data to determine a root-cause of failure. Because failure analysis often involves more than a single step, engineering personnel can employ the system 20 to review initial reports and/or initial testing, determine the type of analysis and testing that should be performed, determine the facility that should perform the testing, review the testing (either in-process, following completion of one of a plurality of planned tests or following completion of planned testing), compare the test results to previous test results for the same or similar items, review contributions by other engineers and personnel, recommend and/or schedule additional testing (including testing that employs one or more specific pieces of lab equipment), prepare reports (including any of preliminary reports, interim reports and final reports) describing one or more conclusions or recommendations in view of the preceding, review any of the preceding types of reports and contribute to any of the preceding types of reports (preliminary, interim and final) that include information from a plurality of personnel. Further, some embodiments of the invention may allow the engineer to perform all of the preceding and additional functions while located remotely from some or all of the other facilities that are employed and/or remote from one or more personnel who are also involved in the failure analysis process.

In general, the technicians 64 perform the testing including operation of lab equipment and may at times also provide some level of analysis 64. In accordance with one embodiment, the technicians are not qualified to independently determine a root-cause failure of a microelectronic product. Instead, according to this embodiment, a preliminary conclusion reached by a technician as to a root-cause of failure is reviewed for accuracy by an engineer or other analyst.

As mentioned above, the customers 66 may include either or both internal customers (i.e., customers within the same company as the individuals performing the failure analysis) or external customers (customers employed by an entity/company that is different than the entity performing the testing).

Further, in some embodiments, the system 20 includes each of a file server 30, a database server 32 and an image server 55 that can be included in the centralized computer 22. The centralized computer 22 may also include modules such as a communication module 34 and a report generation module 36. The centralized computer 22 can be accessed by the managers 60, engineers 62, technicians 64, customers 66, and labs 68 (both equipment and personnel located at the labs) via a network 28, for example, over a wide area network such as the internet. Thus, the network can allow these individuals and facilities both read and write access to data available at the centralized computer 22. Further, the network can also provide a communication link between these individual facilities and individuals, for example, for communication via, for example, email, instant messaging, text messaging, etc.

As illustrated by the preceding, one advantage provided in some embodiments is the availability of a common set of information concerning a particular failure analysis job or jobs. That is, the collaborative process can be greatly facilitated where a wide range of individuals and facilities involved in a failure analysis job or jobs can share information in real time, update information in real time and review common information concerning the current job, prior jobs or incoming jobs in real time. The collaborative process facilitated by some embodiments provides for an efficient system for adding information concerning the failure analysis, revising information concerning the failure analysis, sharing recommendations concerning the failure analysis and reporting the findings/recommendations concerning the failure analysis.

For example, in one embodiment, the centralized computer includes a report generation module (e.g., the report generation module 36) that includes a module that can aggregate information from a plurality of reports into a report that includes information provided by a plurality of users (e.g., a “final” report). In a further embodiment, the report generation module can also include test results, image data and the like in the report. In various embodiments, the data (either or both of analysis or test data) may have been provided to the centralized computer from a plurality of geographically remote locations.

In accordance with one embodiment, the system 20 can store and manage images that are received directly from physical analysis systems including remote physical analysis systems. In some embodiments, the system 20 allows users to employ vector-based editable annotations with images and also to attach user comments to image files. In a version of this embodiment, the user comments may include analysis of the root-cause of a failure of a microelectronic product.

According to some embodiments, the report generation module automatically gathers related information from one or more reports and/or one or more image files for inclusion in a single report. In one embodiment, the information included in the report includes either or both of images that include vector-based annotations and attached user comments.

Various embodiments also provide improved administration, management and statistical analysis of failure analysis that is performed with the system 20. For example, the system 20 can generate reports concerning cycle time, lab efficiency, success rates in determining root-causes of failures, job progress and billing information. The centralized web-accessible nature of some embodiments allows users who are remote from the centralized computer 22 (and from one another) to contribute to these reports and to initiate the generation of these reports.

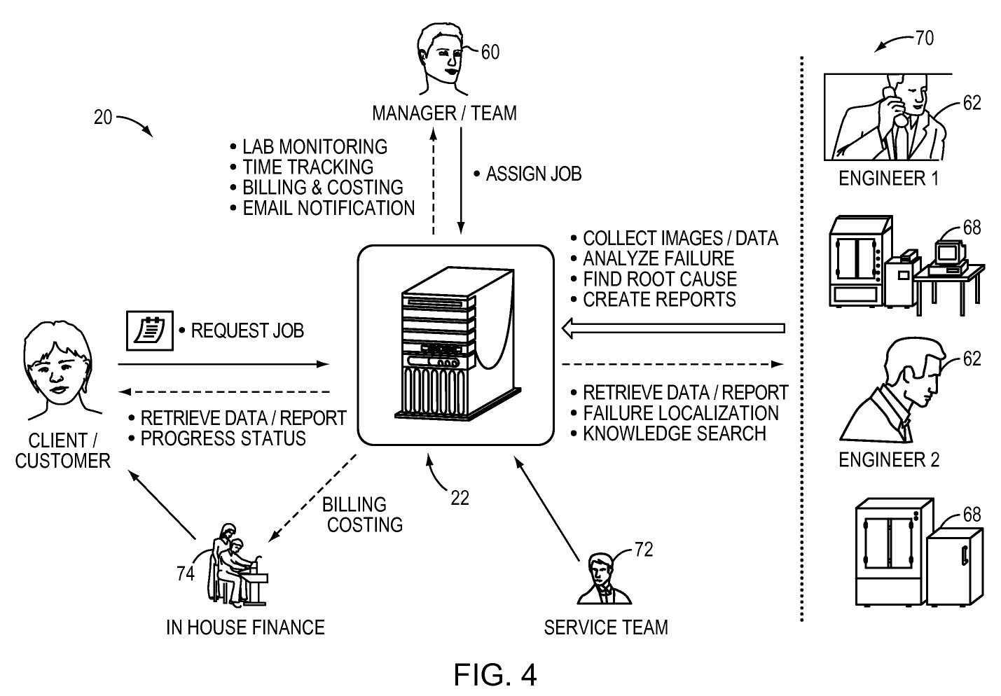

Referring now to FIG. 4, a flow diagram of the various activities supported by the computer-based system 20 is illustrated. In accordance with one embodiment, the computer-based system 20 is a web-based system. In one embodiment, a plurality of resources 70 including engineers 62 and the lab equipment 68 are included as part of a failure analysis resources that can be employed to various degrees in the process of identifying a root cause of a failure, for example, a failure of a microelectronic product.

The computer-based system illustrated in FIG. 4 includes a centralized computer 22 and various communication paths that are represented by solid and dashed arrows to connect users who employ the centralized computer 22. In some embodiments, each of the communication paths is included in a wide area network. The users can include the service team 72, the manager 60 and the project team that may include one or more engineers, a customer 66 and administrative personnel 74. Further, in some embodiments, each of the communication paths is bi-directional. Accordingly, in some embodiments, one or more individuals who are remote from the centralized computer 22 have both read and write access to one or more of the servers included in the centralized computer 22.

In accordance with one embodiment, the manager 60 assigns jobs to the team 70. Execution of the assigned jobs result in the collection of images and/or other data, analysis of the failure and findings concerning a root cause of the failure. Further, engineers 62 or other personnel may create one or more reports concerning the preceding. The team 70 may employ the centralized computer 22 to retrieve data and reports, to perform failure localization and to perform knowledge searching. In accordance with one embodiment, knowledge searching includes an ability to search and refer to prior test results from one or more prior jobs to determine whether the current job includes any indications or conditions that may have been seen in one or more preceding jobs. Thus, the knowledge search allows members of the project team 70 to leverage historical information concerning past jobs and use that information to better determine a root cause of failure concerning the current job.

In one embodiment, the computer-based system 20 allows a user to conduct a search of either or both of image files, report files or any combination of the preceding and other files. The searches may be conducted on either or both of historical information and information concerning current jobs, e.g., test results and/or reports.

The manager 60 as well as other personnel including the engineer 62, service team 72, administration personnel 74 and customers 66 may use the computer-based system to monitor the activities of the various labs, to track the time spent on the current and past jobs, to perform billing and costing as well as to communicate via email. Data entry concerning analysis, any of the preceding and other elements of the process (including administrative elements) can also be performed by the appropriate members of the failure analysis team. In accordance with one embodiment, automated email notifications are sent to one or more of the parties illustrated in FIG. 4 at various stages of a failure analysis job. According to a further embodiment, the system may employ automated instant messaging notifications and/or automated text messaging notifications that are sent to one or more of the parties illustrated in FIG. 4.

In accordance with one embodiment, various levels of access authorization to the centralized computer 22 may be utilized. For example, administrative personnel 74 may have limited access that allows them to access only billing and costing information maintained in the centralized computer 22. As another example, customer 66 may employ the computer-based system 20 to request jobs, retrieve data and reports concerning the jobs as well as review the progress-status of requested jobs. In the case of reports, the customer's access authorization may be restricted to completed reports authorized (for example, by an engineer or manager) for release to the customer. Other levels of access authorization may be employed and may be customized for individuals, a particular group of individuals and/or jobs.

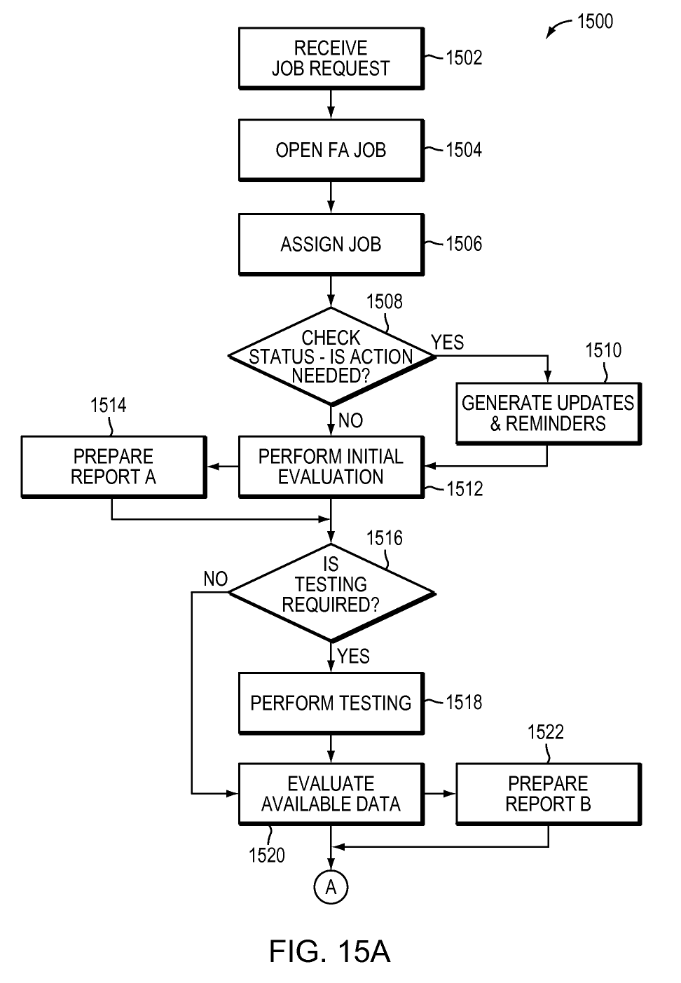

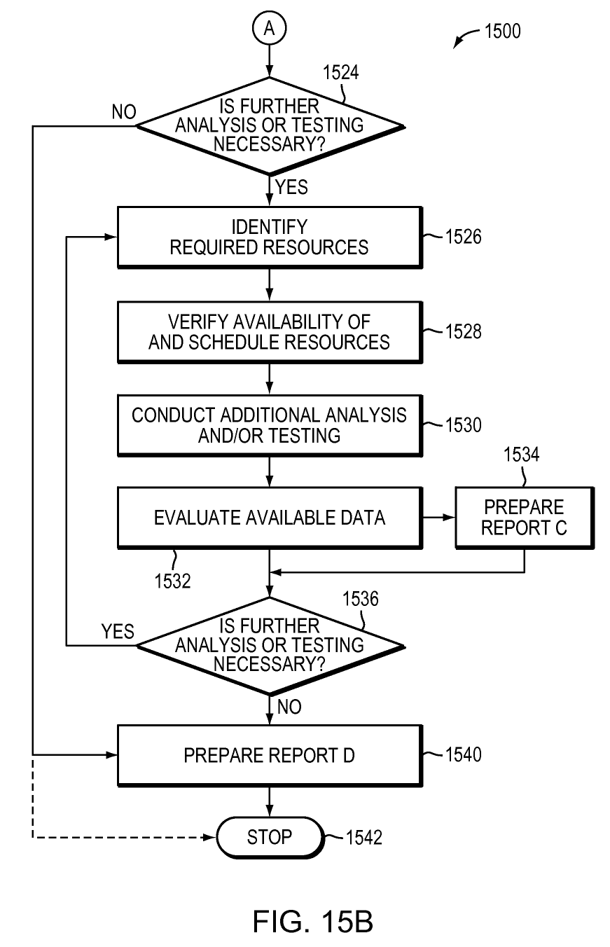

FIGS. 15A and 15B refer to a process 1500 which can utilize a system, such as embodiments of the system 20 illustrated in FIGS. 1-4, to allow a group of individuals at facilities remote from one another to collaborate on a performance of a failure analysis job. In the illustrated embodiment, a job request for a failure analysis job is received at act 1502. In various embodiments, the job request can be received from any of an external customer, an internal customer or a member of the failure analysis team. In accordance with a further embodiment, a job request is entered into the system upon receipt of a work piece (e.g., a defective microelectronic product) by a member of the failure analysis team. The team member that opens a job need not be an engineer or manager. For example, in one embodiment, the team member is a member of an administrative staff such as a receiving clerk located at the facility that receives the work piece.

At act 1504, a job is opened, for example, a job number may be assigned the failure analysis job. In one embodiment, the job number is automatically assigned. The act of opening a job can also include the entry and/or generation of additional information concerning the job. For example, the act 1504 may include a summary of the condition of the work piece, a testing request that can include one or more tests requested by the customer or identified as appropriate by the individual who opens the job.

At act 1506, the job is assigned. Job assignment may involve an identification of an individual responsible for completion of the job and/or coordination of the tasks involved in the job. In accordance with one embodiment, for example, the job assignment is made in view of a scheduling objective included in the job request. Accordingly, an individual and/or an organization can be assigned the job in various embodiments. According to one embodiment, an individual is assigned the job in part based on the organization and resources with which he or she is associated.

In some embodiments, status checks which may or may not be automated may be routinely and/or periodically performed such that updates and reminders are generated. These updates and reminders may refer to scheduling objectives, the allocation and/or availability of resources and the like. For example, at act 1508 a status check is indicated and act 1510 an update or reminder is generated as a result of the status check. These status checks can be performed throughout the process 1500. Thus, although the illustrated embodiment provides a single act 1508 that includes a status check, the process 1500 may included a plurality of status checks which may be located at various stages of the process 1500. For example, a status check may be included following one or more acts that provide for testing (status check: has analysis of the test data been performed?), following one or more acts that provide for analysis (status check: is a report of the analysis complete?), or elsewhere within the process 1500. According to one embodiment, the act 1510 includes the automatic generation and transmission of any of emails, instant messages or text messages concerning updates and reminders.

At act 1512, an initial evaluation of the item is performed. The act 1512 refers to the evaluation first performed following an opening of the failure analysis job. Thus, act 1512 does not preclude analysis done concurrent with the job opening (act 1504) or prior to the job opening, for example, where the customer has performed some level of analysis before forwarding the work piece to the failure analysis team. Accordingly, where the item is a microelectronic product, the initial evaluation may include any of reviewing customer comments concerning a failure of the product or reviewing actual test data that is available concerning a product failure. For example, the failure may have been detected during a manufacturing process that includes one or more tests and the data associated with those test(s) may be available for the initial evaluation. As a result of the initial evaluation one or more reports may be prepared, for example, at act 1514 a report A is prepared as a result of the evaluation performed at act 1512. In some cases, the initial evaluation may be sufficient to determine a root-cause of the failure and the process may conclude with the preparation of a report concerning the results of the evaluation performed at act 1512.

In the illustrated embodiment, the process 1500 includes the preparation of a plurality of reports. In some embodiments, one or more of these acts may include the generation of a standalone report (i.e., a discrete report), the addition of further information to an existing report (e.g., a cumulative report) or a combination of each of the preceding, for example, where some of the information provided in a standalone report is also used to update a cumulative report. Further, the report preparation can involve the generation and transmission of one or more report forms from a centralized computer to an engineer located remotely from the centralized computer. In addition, a first engineer may prepare a first report during the process 1500, a second engineer (located remotely from one or both of the centralized computer and the first engineer) may prepare a second report and information from the first report and the second report may be included in the cumulative report. The cumulative report may also include information provided by other contributors, for example, by administrative staff, engineering managers, etc. In further embodiments, the reports are stored on a file server included in the centralized computer even where the engineers are located remote from one another and/or remote from the centralized computer. In some embodiments, the process allows for the preparation of interim reports that provide users with an ability to check on the status of a job prior to the completion of the job, for example, when a preliminary root-cause analysis is complete and documented in the interim report and/or where only some of the expected test results and/or data is available.

The process 1500 may include a plurality of evaluation steps. In some embodiments, the purpose of the evaluation step(s) is to identify a root-cause failure of an item, for example, a microelectronic product based on the available information. Accordingly, each evaluation point included the process 1500 can provide an opportunity to reach a conclusion regarding the root-cause of failure or the need for further analysis or testing.

At act 1516, a determination is made whether testing is required. At act 1518, additional testing is performed in response to a determination that the testing is required. In accordance with some embodiments, the testing performed at act 1518 may include a plurality of tests. For example, a lab may include facilities capable of performing a plurality of physical tests on a microelectronic product. Accordingly, an engineer/analyst may determine that the product should be sent to the lab for a plurality of tests that may provide data to assist in the failure analysis. In further embodiments, multiple labs are involved in the testing performed at act 1518.

If testing is not required, or subsequent to the testing performed at act 1518 an evaluation step is performed at act 1520. The evaluation may include an evaluation of the test data, the contents of report A or other information available concerning the item under review. In general, the evaluation is performed by an individual or individuals qualified to determine a root-cause of failure, for example, an engineer or other qualified analyst. The results of an evaluation may include the preparation of a report, or the contribution of additional material to a previously generated report. Accordingly, in the illustrated embodiment, a report B is prepared at act 1522 following the act of evaluating available data at act 1520.

At act 1524, an assessment is made regarding whether further analysis or testing is necessary in view of the information, conclusions, and/or recommendations resulting from the prior acts. Where a determination is made that no further analysis or testing is necessary a report, for example, a final report may be prepared. In the illustrated embodiment, a report D is prepared at act 1540 and the process concludes at act 1542. The contents of the report D may include information included in report A, information included in report B, and/or other information available from the preceding acts. In accordance with one embodiment report D integrates the contents of report A and report B as well as any other reports that may be prepared as a result of the process 1500. Alternatively, as shown in phantom, the process 1500 may conclude at act 1542 without the preparation of the report D at act 1540.

Where at act 1524, the determination is made that additional analysis or testing is necessary the process 1500 can move to an act 1526 where required resources are identified. At act 1528, the availability and scheduling of those resources may occur. As mentioned above, various embodiments provide information to those parties who are doing the scheduling in order to accurately identify the availability of resources and to coordinate the multiple uses of the resources employed on a plurality of failure analysis jobs. Further, although acts 1526 and 1528 are shown once in the illustrated embodiment, the acts 1526 and 1528 may be included at a plurality of points in the process 1500. For example, the acts 1526 and 1528 can be: 1) included prior to or as a part of the act 1506, 2) included subsequent to the act 1506 and prior to the act 1512; and/or 3) subsequent to the act 1516 and prior to the act 1518.

At act 1530, the analysis or testing is conducted. At act 1532, a further evaluation is performed on the data available from the preceding acts. Here too, a report can be prepared. Accordingly, in the illustrated embodiment, a report C is prepared at act 1534. The process may then move on to act 1536 where a determination is again made concerning whether further analysis or testing is necessary. If such testing or analysis is necessary, the process 1500 may move to act 1526 and repeat one or more of the acts of: identifying required resources; scheduling those resources; conducting the additional analysis and/or testing; and evaluating the data to determine a root-cause failure of the item under review. Where, at act 1536 it is determined further analysis or testing is not necessary an aggregate report may be prepared, for example, a report D may be prepared as indicated at act 1540. According to one embodiment, the report generation module generates one or more of reports A, B, C and D.

The process 1500 may also include one or more additional acts. For example, the process 1500 may include an act whereby the job costs are evaluated to determine whether the costs are approaching (or may have exceeded) a budget for the job. According to this example, a customer may have established a project budget that requires the failure analysis to either be completed within budget or stopped (even if incomplete) when a maximum cost is reached. Similarly, a project schedule may be established such that the customer or other party to the job is notified when a job appears likely to exceed (or may have exceed) the time allotted for the job. This situation may also create a (either a temporary stop or a permanent stop) for the process 1500, for example, based on a decision from the customer and/or a manager. As another example, the lab and/or personnel responsible for completion of the failure analysis may find that they are unable to identify a root cause given the available lab equipment and/or the knowledge of the analysts. Accordingly, the process 1500 may include acts corresponding to any of the preceding and/or the associated stop-point(s).

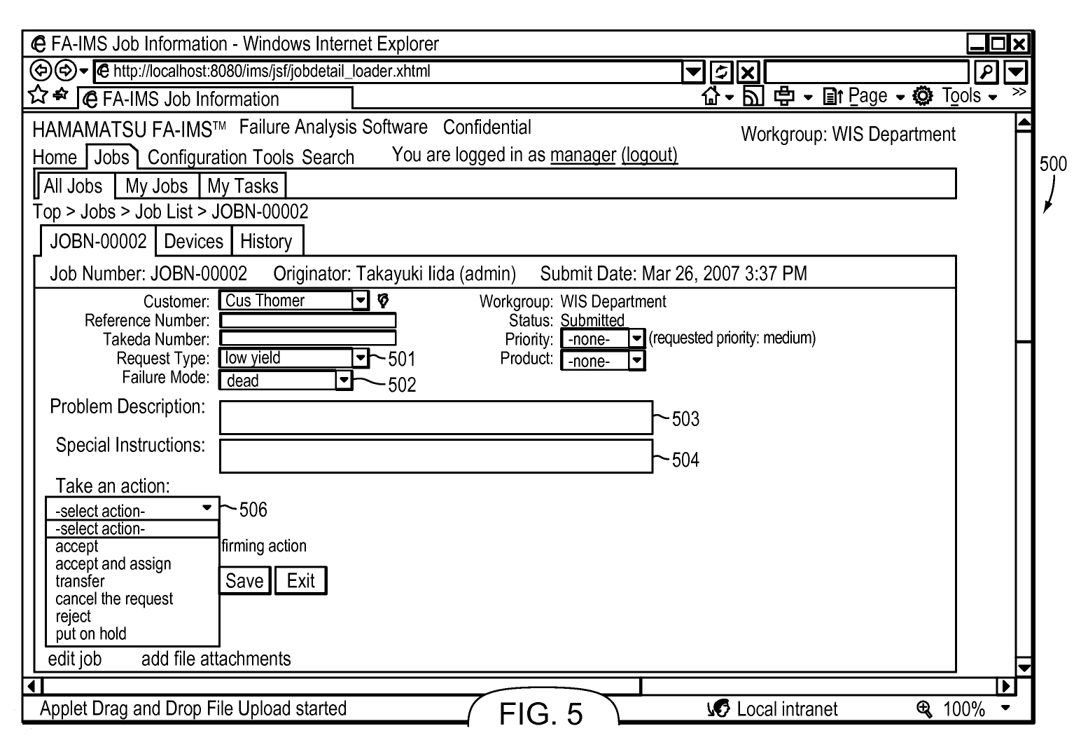

The comprehensive functionality for failure analysis provided by the systems described herein lends itself to the entry of a variety of information that can be stored at the centralized computer. Accordingly, embodiments of the invention provide a plurality of displays (e.g., web-based forms) suitable for entry of information concerning the failure analysis process. In some embodiments, these displays are generated in a web browser of a user. In various embodiments, the displays illustrated in FIGS. 5-14 are employed by managers, engineers/analysts and administrative staff as appropriate.

Referring now to FIG. 5, a display 500 in accordance with one embodiment, is illustrated. Here, a JOBN-00002 has been submitted for the failure analysis team via the computer-based system 20. For example, a customer, administrative staff, etc. may have submitted the information concerning the job. That information may have been communicated from a remote computer via the network 28 to the centralized computer 22 where the information concerning this JOBN-00002 is centrally stored. According to one embodiment, a user employs the display 500 to assign engineers, schedule laboratory testing and in some instances perform analysis themselves. In FIG. 5, the user has received the request, a job has been opened with a request type (low yield) and a customer-described failure mode of “dead.” The display includes a first field for selecting the request type 501, a second field for identifying the failure mode 502, a text box for entry of a problem description 503, and another text box for entering any special instructions 504.

In addition, the display 500 can include a pull down menu 506 to select an action. The action can include any of accepting the job, accepting and assigning the job, transferring the job, cancelling the job-request, rejecting the request and placing the job on hold, etc.

In accordance with one embodiment, the user is a manager who assigns a newly received job to one or more engineers. In accordance with one or more embodiments, the assignment of a job or task related to a particular job automatically generates an email notification to the selected personnel.

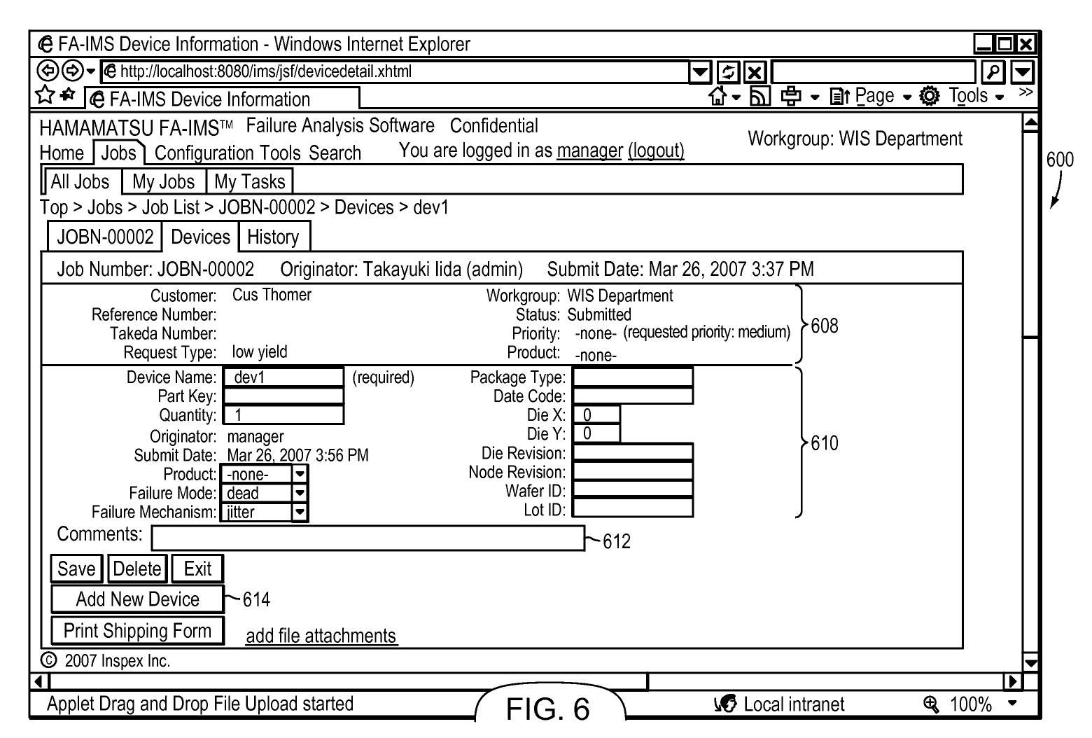

Referring now to FIG. 6, a display 600 includes a variety of information concerning a device that will be analyzed as part of a job. In accordance with one embodiment, a device is a microelectronic product and the information appearing in the display 600 may include the customer name, the job number, the originator of the job, and the date in which the job was submitted. In addition to the preceding, the display may include one or more fields 608 that include additional identifying information associated with the job. For example, this information may include a reference number, a request type, a work group, a status, a priority, and a product. In a further embodiment, the display 600 may include a plurality of fields 610 in which the user may enter further details concerning the device, for example, device information. The device information can include a device name, a part key, a quantity, the identification of an originator, a product, a failure mode, and a failure mechanism. In addition, in this embodiment, the device information may include a package type, a date code, a die identification, a die revision, a note revision, a wafer ID, a lot ID or any other information of value to the specific process and/or fab. This additional device information may be relevant to identifying one or more additional devices that may be subject to the same failure mode as the device being analyzed in the current job. That is, where a particular package type manufactured within a certain time frame (e.g., as identified by the date code) has a quality related failure, these failures may be consistently reflected across similar devices manufactured during the same period of time. As mentioned above, a knowledge search may later be employed and the failure analysis associated with this job and this device may be relevant to identifying similar failure modes in other jobs and other devices.

In accordance with a further embodiment, the display 600 may also include a comment section 612 which can include information concerning the device and/or analysis conducted to-date. In addition to the above, in accordance with one embodiment, the display 600 may also include a control element 614 that allows additional devices to be added to the job where the job includes a plurality of devices.

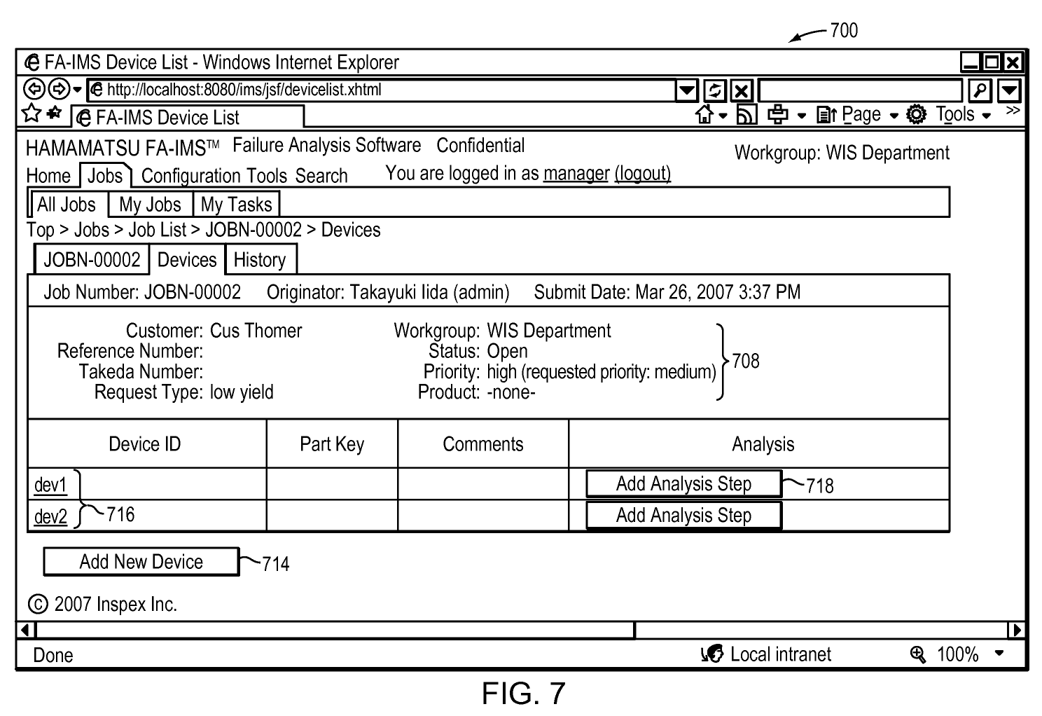

Referring now to FIG. 7, a display 700 is illustrated in which a plurality of devices are associated with a job, e.g., the job JOBN-00002. In accordance with one embodiment, the display 700 identifies each of the plurality of devices 716, e.g., dev1, dev2, etc. In addition, for each of the devices, a part key, comments, and analysis fields are also included in the display. In accordance with one embodiment, the display 700 may include one or more additional control elements such as a control element 714 that allows an addition of further devices to a particular job. Also, a control element 718 may be associated with each device where the control element allows a user to add an analysis-step. That is, the control element 718 may be employed by a user such as an engineer to initially identify a first set of analysis for the device(s). The same user or a different user can subsequently modify/add/delete those analysis steps, for example, based on information received as a result of the completion of the first step of analysis.

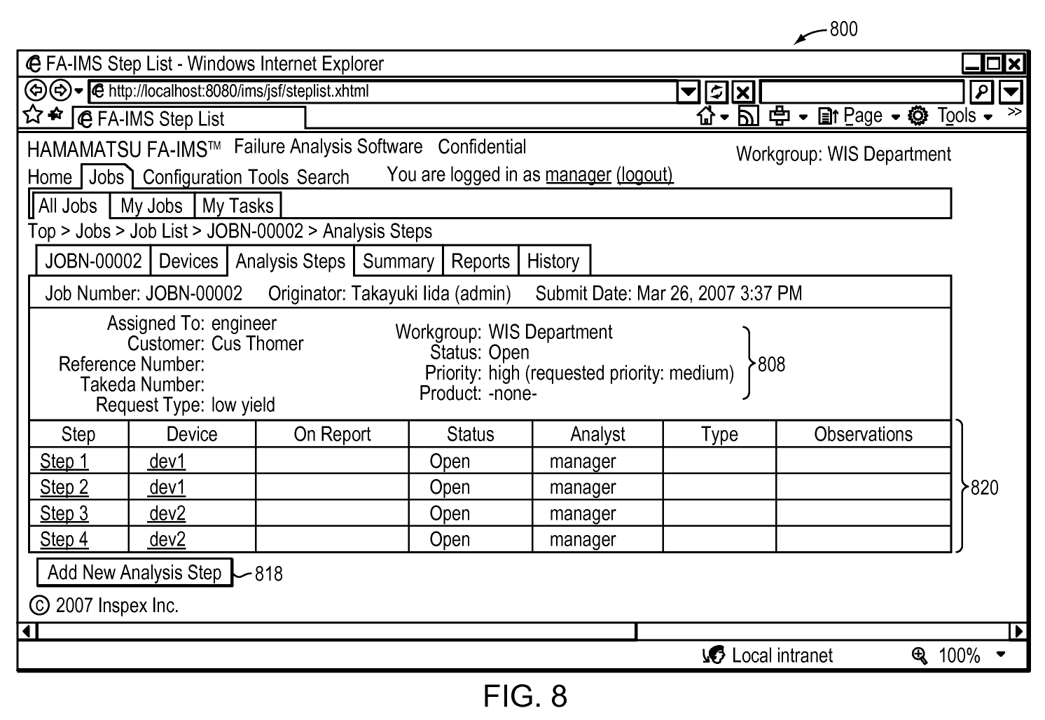

Referring now to FIG. 8, a display 800 is illustrated for a specific job that includes a plurality of devices (i.e., dev1 and dev2) and a plurality of steps associated with each device. In the illustrated embodiment, a plurality of fields 820 provides information concerning the steps and devices. For example, for each step and device, a status field may be employed as well as an identification of the responsible analyst. In addition, the type of analysis and any observations may also be recorded in the fields 820. Further, the display may include a control element 818 that allows the addition of further analysis steps. In addition, in one or more embodiments, the display 800 may include identification fields 808 as previously described, that also include an identification of an engineer that the job has been assigned to. The assignment in accordance with one or more embodiments is accomplished by the manager employing the computer-based system 20 to electronically enter the assignment and communicate the assignment to the assigned individual or group. As indicated above, the locations and/or facilities where each of the manager and one or more engineers are located may be physically remote from one another, for example, the manager may be located at a first location and an engineer may be located at a second location that is geographically remote from the first location. Regardless, however, embodiments allow each of the manager(s) and engineer(s) to review the display 800 and to modify the contents of the display 800 even where one or more of the users are remotely located from the centralized computer.

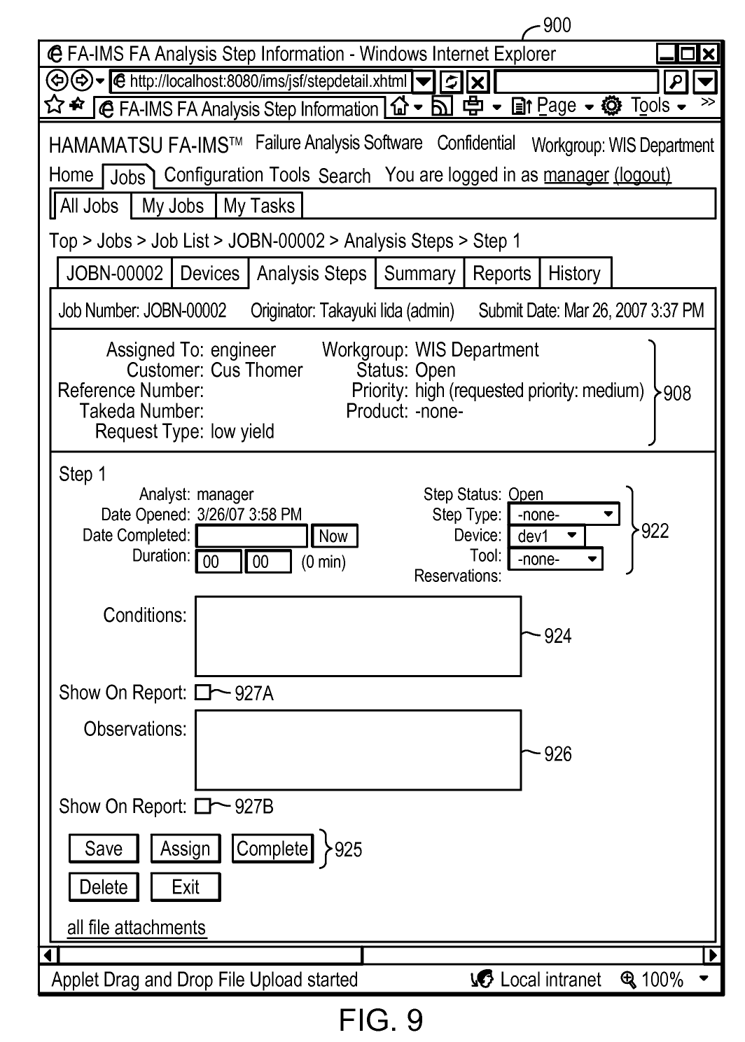

Referring now to FIG. 9, a display 900 illustrates information associated with a particular analysis step. In the illustrated example, the step is identified as Step 1 from job JOBN-00002. In accordance with one embodiment, the display 900 may include information fields 922 including some that are populated with information that was entered previously concerning the job or step such as the identification of the analyst and the status of the step. Other fields allow the analyst to select and fill in the requested information. In accordance with one embodiment, the requested information includes the date completed, the step type, the device, and a tool (where a lab tool is employed). In accordance with the illustrated embodiment, the display 900 may also include a conditions field 924 and an observations field 926. These fields may be employed, for example, to provide the description of the conditions identified during the analysis step and to provide a description of any additional observations, respectively.

Further, the display 900 can also include a set of control elements 925 that allow the analyst to save the results of the analysis as entered in the display, to assign further analysis (for example, as a result of a determination made during the analysis step) or to identify the analysis step as complete. Various embodiments allow the analyst to save the results of the analysis step in, for example, a server included in the centralized computer even where the user is employing a remote computer to enter the results.

In addition, the display 900 may include elements 927A and 927B that allow the analyst to select whether the comments included in the conditions field 924 and the observation field 926, respectively are to be included in a report. As described above, the report may be either of a cumulative report that includes data from a plurality of analysis steps or a report specific to a particular analysis step or subset of analysis steps included in a larger analysis process.

In accordance with one embodiment, the analysis may be the result of the observations of an analyst on data supplied from the customer, test results conducted by the analyst or engineer or laboratory test results provided from a piece of laboratory test equipment that is operated by another member of the failure analysis team, for example, a technician. In accordance with one embodiment, the system hosts a tool reservation module.

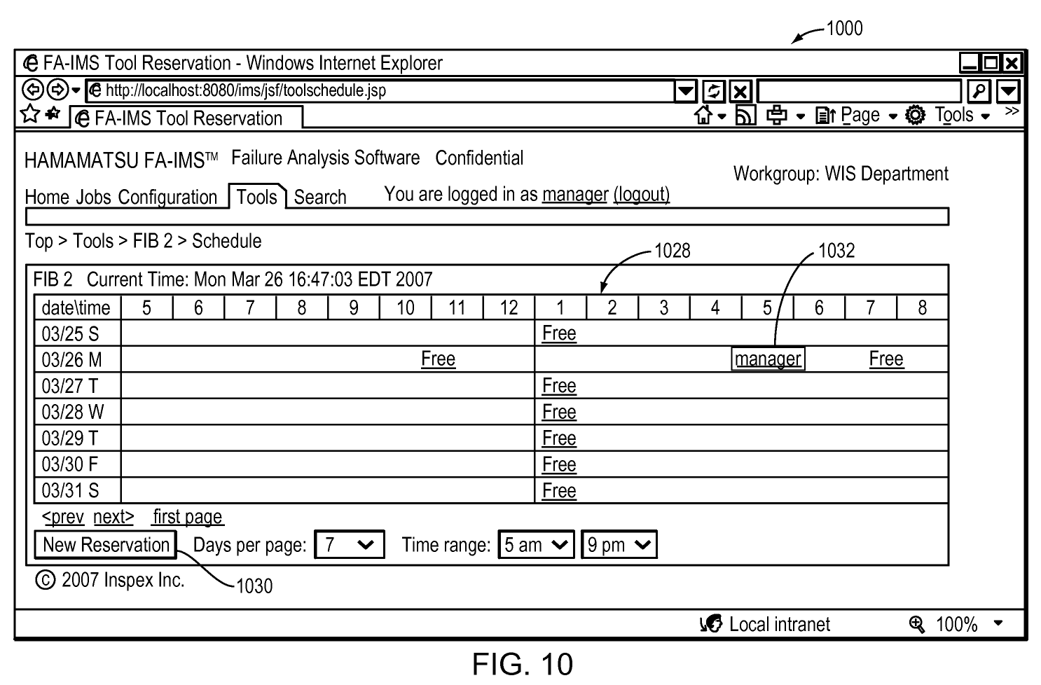

Referring to FIG. 10, a display 1000 includes a scheduling calendar 1028 and a control element 1030 in accordance with one embodiment. As described above, the computer-based system can allow authorized individuals to schedule analytical tools that can be employed to gather data to assist in the failure analysis. For example, various physical parameters can be measured with a variety of test equipment. Accordingly, these analytical tools can, for example, include any of an electron microscope, operational testers that apply input signals to a chip and check the outputs that are generated in response, e-beam probes, focused ion beam probes, spectrometers, emission microscopes (e.g., photo and thermal emission microscope systems, IR emission microscope systems), thermal and photoelectrical laser stimulation systems, etc. In accordance with one embodiment, the computer-based system 20 provides scheduling tools to assist members of the failure analysis team in scheduling the tooling and the test equipment required to gather data concerning the failure analysis. Accordingly, a specific tool, in this instance, FIB 2 may be scheduled using the scheduling calendar 1028. In the illustrated embodiment, the calendar includes a plurality of dates and times and an indication of the availability of the tool. In one embodiment, new reservations can be made using the control element 1030. In a further embodiment, indicia 1032 concerning an identification of the party who has reserved the equipment may also appear in the scheduling calendar.

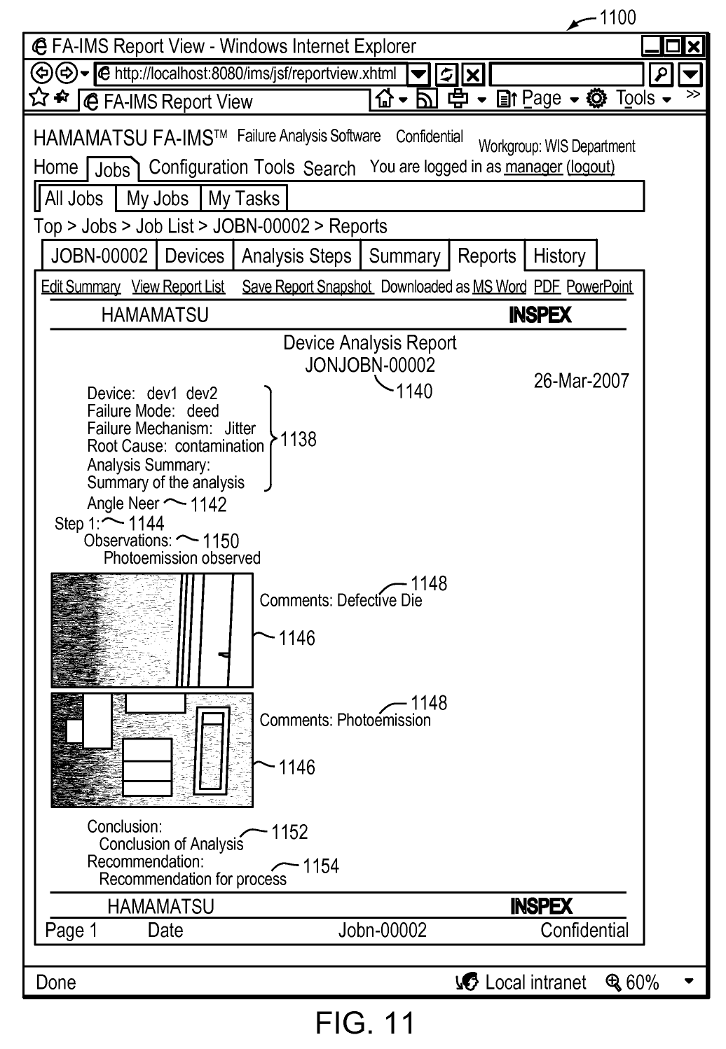

In accordance with one embodiment, the analysis performed by a plurality of members of the analysis team and data generated by testing performed on one or more devices may be included in a job report. Referring now to FIG. 11, in one embodiment, a job report includes identification fields 1138 and a job identification field 1140. Further, the display 1100 may also include an identification of one or more analysts 1142 and an identification of one or more steps 1144 included in the report. In accordance with a further embodiment, the display 1100 can include one or more images 1146 and associated comments 1148. For example, in the illustrated embodiment, the first image includes a comment “defective die” and a second image 1146 includes the comment 1148 “photo emission”. In addition, the report may include a notation concerning observations 1150, for example, an observation that photo emissions have been observed. The job report may also include a conclusion 1152 in which the one or more conclusions that are reached as a result of the analysis is presented. Further, the report may also include recommendations, for example, recommendations to improve a process that may have contributed to the failure that is detected and the root cause of the failure. Also, as indicated above, the report can include information provided by a single analyst, multiple analysts or either of the preceding and information provided by other contributors.

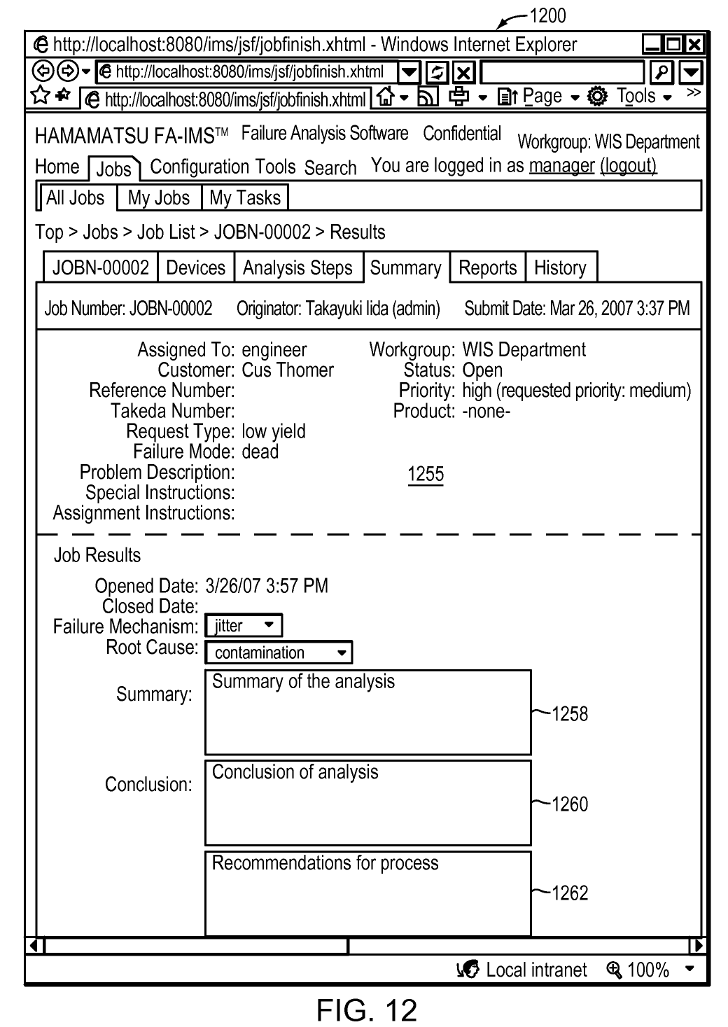

Each job may include a plurality of devices and analysis steps and all of the preceding may be included in a summary report for the job. Referring now to FIG. 12, a display 1200 is illustrated in accordance with one embodiment. The display 1200 may include a region 1255 that includes identification information as well as descriptive information. In one embodiment, the region 1255 includes identification information concerning the item being analyzed, the individual responsible for the job, the work group, the customer, and the status of the job. In addition, however, the region 1255 can also include the reference number and information concerning a priority of the request and an identification of the product. A request type and a failure mode may also be described. Further, the region 1255 may include a problem description, special instructions, and assignment instructions.

In addition, the display 1200 may include a field 1256 concerning a failure mechanism, a field 1257 concerning a root cause of the failure, a region 1258 for entering a summary of the analysis, a section 1260 for entry of a conclusion of the analysis and a section 1262 for entry of recommendations for the process or other recommendations. In accordance with one embodiment, the display 1200 includes information that can be updated to reflect the progress of a failure analysis process, e.g., the process 1500, until its completion.

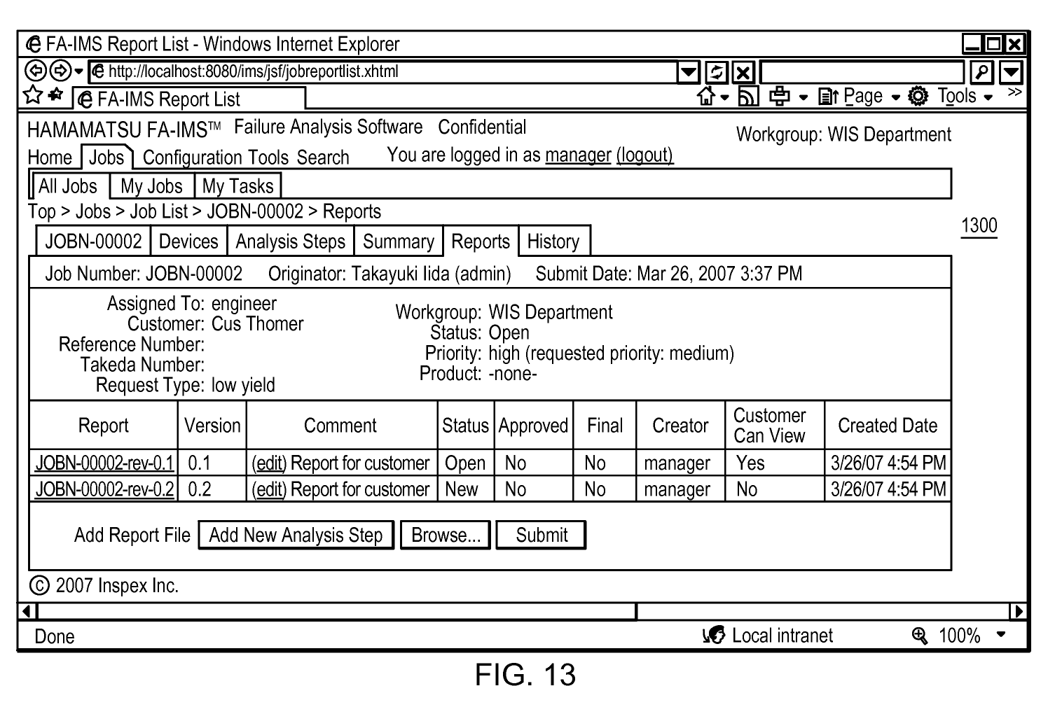

In addition to a summary for a job that addresses the devices and the analysis steps, each job may also be associated with one or more reports. Referring now to FIG. 13, a display 1300 may list a plurality of reports associated with a single job. For example, in the illustrated embodiment, a first report JOBN-00002, version 1 and a second report JOBN-00002, version 2 are identified. The reports can also be associated with a further identification (e.g., Report for customer, Report for manager), a status (e.g., open, new, complete), an approval (e.g., yes, no), an indication of whether the report has been finalized, a creator, an access identifier which may, for example, limit access to a selected group of individuals, and a creation or last modification time/date.

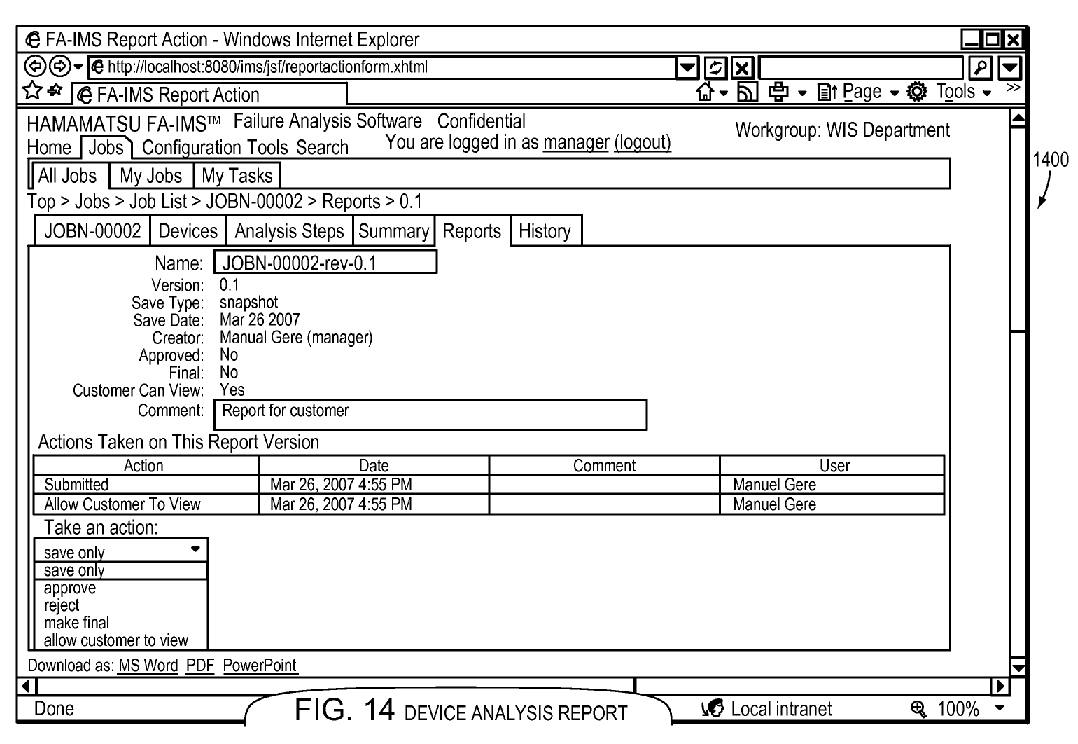

In addition to the preceding, the various fields can be updated in a further embodiment. For example, referring now to FIG. 14, a display provides access to details concerning a report JOBN-00002 version 1. In accordance with one embodiment, the display allows a user to take an action such as saving the report, approving the report, rejecting the report, establishing the report as final and revising the permitted access to the report, etc. Accordingly, in various embodiments, the display 1400 allows an authorized user to update the report.

In accordance with one embodiment, any of the above-described displays can be customized such that they are formatted to meet the specific needs of an end user such as a customer. For example, these modifications can include any of customizing the layout/display of the information in a particular display, providing a unique and consistent look and feel for a set of displays (by adding company specific logos and/or adding or highlighting fields that include information of particular interest, etc.)

Embodiments of the failure analysis systems described herein may communicate to the various users via any of email, instant messaging, and text messaging systems alone or in combination with one another or other communication formats. Accordingly, instant messaging and/or text messaging may be employed as described for any of the above-mentioned email communications.

Embodiments of the failure analysis systems described herein may include software, hardware or a combination of software and hardware. According to one embodiment, the system operates as a web based application and operates on the internet browsers of the remote computers. According to one embodiment, the system is a multi-tier enterprise system based on the Java EE 5 standard. In a further embodiment, the system employs an object-relational mapping that allows an object oriented data design which provides a flexible and extendible architecture. Such an approach can allow the system to reach new users and facilities even where they are geographically remote from the previously existing users and facilities. Further embodiments allow for an efficient integration of individuals who are members of a common organization that employs a matrix-like organizational structure. In addition, embodiments can also support more traditional hierarchical organizational models.

In one embodiment, the report generation module creates JEDEC standard reports (e.g., type JESD-38) in a web based format (e.g., an HTML format). In some embodiments, the forms are generated using script languages such as JavaScript. Further, embodiments may export data collected at the centralized computer from a plurality of remote locations to various document formats such as MSWord, MSExcel, MSPowerPoint, PDF, JPEG and TIFF file types.

Further, embodiments of the system may support a variety of operating systems including those based on Windows, Linux and UNIX. Various embodiments may employ relational database management systems by, for example, Oracle, My SQL, etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of performing failure analysis on a microelectronic product, the method comprising acts of:
storing a result of a first test performed on the microelectronic product on a centralized computer;
transmitting the result from the centralized computer to a first remote computer for an evaluation of the result by a first evaluator; and
transmitting a report form from the centralized computer to the first remote computer for entry of data including analysis supplied by the first evaluator after the evaluation of the result.

2. The method of claim 1, further comprising acts of:
receiving the data at the centralized computer; and
storing the data at the centralized computer.

3. The method of claim 1, further comprising an act of automatically notifying the first evaluator of a performance of the first test.

4. The method of claim 3, further comprising an act of communicating the automatic notification via email.

5. The method of claim 1, further comprising an act of scheduling a second test to be performed on the microelectronic product based at least in part on an evaluation of the result of the first test by the first evaluator.

6. The method of claim 5, further comprising an act of storing a result of the second test on the centralized computer.

7. The method of claim 6, further comprising an act of transmitting the result of the second test from the centralized computer to a second remote computer.

8. The method of claim 1, further comprising an act of transmitting the result from the centralized computer to a second remote computer for an evaluation of the result by a second evaluator for entry of data including analysis supplied by the second evaluator after the evaluation of the result by the second evaluator.

9. The method of claim 8, further comprising an act of transmitting a report form from the centralized computer to the second remote computer for entry of data including analysis supplied by the second evaluator after the evaluation of the result.

10. The method of claim 9, wherein the report form transmitted to the second remote computer includes at least one field populated with data supplied by the first evaluator.

11. The method of claim 10, wherein the report form transmitted to the second remote computer includes at least one field populated with test data generated as a result of the first test.

12. The method of claim 9, wherein each of the centralized computer, the first remote computer and the second remote computer are geographically remote from one another.

13. The method of claim 9, further comprising acts of:
receiving the data including analysis supplied by the second evaluator at the centralized computer; and
storing the data including analysis supplied by the second evaluator at the centralized computer.

14. The method of claim 13, further comprising an act of generating a report including the analysis supplied by the first evaluator and the analysis supplied by the second evaluator.

15. The method of claim 14, further comprising an act of transmitting the report including the analysis supplied by the first evaluator and the analysis supplied by the second evaluator from the centralized computer to a third remote computer.

16. The method of claim 14, wherein the acts of transmitting from the centralized computer are performed using a wide area network.

17. The method of claim 1, further comprising an act of rendering the report form in a web-browser at the first remote computer.

18. A computer-based system for performing failure analysis on a microelectronic product, the system comprising:
a centralized computer including a file server configured to store report forms; and
at least one remote computer configured to be employed by a user qualified to evaluate test data concerning the microelectronic product, wherein the user is qualified to provide a report form with analysis including recommendations for further testing and a determination of a root cause of a failure of the microelectronic product based upon a review of the test data,
wherein the centralized computer is configured to receive the report form from the remote computer over a wide area network and to store the report form on the file server.

19. The computer-based system of claim 18, further comprising a database server configured to store test data concerning testing performed on the microelectronic product.

20. The computer-based system of claim 19, wherein centralized computer is configured to receive the test data from a testing facility over a wide area network.

21. The computer-based system of claim 20, wherein centralized computer is configured to communicate the test data to the at least one remote computer over the wide area network for review by the user.

22. The computer-based system of claim 18, further comprising a report generation module configured to generate a report form to be completed by the user.

23. The computer-based system of claim 22, wherein the report generation module is configured to populate at least one field of the report forms with the test data.

24. The computer-based system of claim 22, wherein the user is a first user, wherein the report generation module is configured to generate a report form to be completed by a second user, wherein the report form to be completed by the second user includes at least one field with analysis provided by the first user, and wherein the second user is qualified to evaluate the test data concerning the microelectronic product and provide analysis including recommendations of the second user for further testing and the determination of the root cause of the failure of the microelectronic product based upon a review of the test data by the second user.

25. The computer-based system of claim 24, further comprising a communication module configured to transmit each of the report form to be completed by the first user and the report form to be completed by the second user from the centralized computer over the wide area network.

26. The computer-based system of claim 18, further comprising a communication module configured to transmit report forms from the centralized computer to remote computers, over the wide area network, for entry of analysis by personnel qualified to evaluate the test data, wherein a report form may include information provided by a plurality of personnel qualified to evaluate test data concerning the microelectronic product.

27. The computer-based system of claim 18, wherein the at least one remote computer is located geographically remote from the centralized computer.

28. A method of performing failure analysis on a microelectronic product, the method comprising acts of:
storing a result of a first test performed on the microelectronic product on a centralized computer;
transmitting the result from the centralized computer to a first remote computer over a wide area network for an evaluation of the result by a first evaluator; and
storing at the centralized computer data received from the first remote computer,
wherein the data includes analysis supplied by the first evaluator after the evaluation of the result.

29. The method of claim 28, further comprising an act of transmitting a report form from the centralized computer to the first remote computer for entry of the analysis supplied by the first evaluator.

30. The method of claim 29, further comprising an act of rendering the report form in a web browser of the first remote computer.

31. The method of claim 28, further comprising an act of transmitting the result from the centralized computer to a second computer for an evaluation of the result by a second evaluator.

32. The method of claim 31, wherein the second computer is a remote computer, and wherein the act of transmitting the result from the centralized computer to the second computer includes an act of transmitting the result from the centralized computer to the second computer over a wide area network.

33. The method of claim 31, further comprising an act of transmitting the data from the centralized computer to the second computer.

34. The method of claim 31, further comprising an act of storing at the centralized computer data received from the second computer, wherein the data includes analysis supplied by the second evaluator after the evaluation of the result by the second evaluator.

35. The method of claim 34, further comprising an act of generating a failure analysis report including analysis supplied by the first evaluator and the second evaluator.

36. The method of claim 35, further comprising an act of including the result of the first test in the failure analysis report.

37. The method of claim 28, further comprising an act of receiving a request for failure analysis from a requester.

38. The method of claim 37, further comprising an act of automatically scheduling the first test following a receipt of the request.

39. The method of claim 28, further comprising an act of automatically notifying the first evaluator of a performance of the first test.

40. The method of claim 28, wherein the result includes information concerning at least one of an electrical failure and a physical failure of the microelectronic product.
